(19) United States
(12) Patent Application Publication
(10) Pub. No.: US 2008/0046232 A1
(43) Pub. Date: Feb. 21, 2008

(54) Method and System for E-tol English language test online

(76) Inventors: Jan Groppe, Celaya (MX); Maria Eugenia Garcia Groppe, Celaya (MX)

Correspondence Address: FURR LAW FIRM, 2622 DEBOLT ROAD, UTICA, OH, 43080, US

(21) Appl. No.: 11/465,794

(22) Filed: Aug. 18, 2006

(51) Int. Cl. G06F 17/27

(52) U.S. Cl. 704/9

(57) ABSTRACT

The present invention is an Internet-based English language test online designed to help Human Resources Departments in Non-English speaking countries find the right person for the bilingual job, The system will also assess employee's English language communication skills, on a scale from 0-100%. The system is job-business oriented and measures the participant's skills and proficiency for effective communication at the workplace. The system will have a standard test with a follow up VIP test if the test taker qualifies after taking the standard test.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND

1. Field of the Invention

The present invention relates to a method and system for testing English proficiency and more particularly one that runs and processes on the Internet.

2. Description of Prior Art

With the world becoming a smaller and smaller place there exists a need for employers in Non English speaking countries to test the English proficiency of candidates through a Job Entry test, in order to choose the right person for the bilingual job. These candidates may or may not be in the local area at the time of the test and interview.

There are only a few English Language Tests online. Most of the current tests are paper tests, that are long (2 hrs or more), “schoolish”, academic, classroom-campus-oriented and absolutely irrelevant for communication at the workplace. Most of these tests were originally designed as University Entry Tests and are therefore totally inappropriate as Job Entry Tests. Furthermore these tests do not provide good methods of testing applicants and students given the global marketplace.

### PRIOR ART

U.S. Pat. No. 6,907,546 by Haswell, et al. and issued on Jun. 14, 2005, is for a language-driven interface for an automated testing framework. It discloses an invention in which, to test the functionality of a computer system, automated testing may use an automation testing tool that emulates user interactions. A database may store words each having a colloquial meaning that is understood by a general population. For each of these words, the database may store associated computer instructions that can be executed to cause a computer to perform the function that is related to the meaning of the word. During testing, a word may be received having a colloquial meaning that is understood by a general population. The database may be queried for the received word and the set of computer instructions may be returned by the database. The automated testing tool may then perform the function returned to the colloquial meaning of the word. The words stored in the database may be in English or another language.

U.S. Pat. No. 6,808,267 by O'Neil, et al. and issued on Oct. 26, 2004, is for a method for automated mass screening for visual dysfunction in children. It discloses a method for automatically screening for visual dysfunctions in preliterate or pre-school test subjects that incorporates collecting personal profile and background information and transferring the information to a local storage system. The information is retrieved into a PC system and a test procedure is initiated with a test subject by establishing an exclusive dialog between the test subject and the PC system. The test procedure is in the form of a game selectively attractive and readily understood by preliterate or school-age test subjects.

U.S. Pat. No. 6,676,413 by Best, et al. and issued on Jan. 13, 2004, is for a method and system for preventing illiteracy in substantially all members of a predetermined set. It discloses a method and system for preventing illiteracy and achieving grade-level literacy in substantially all members of a predetermined set of students, including the steps of administering standardized oral fluency measures, recording the test results in a database, calculating a standardized predictive measure of literacy for each student, presenting a report for each student including recommendations of curriculum and instruction time, and determining a schedule for each student for repeating the steps of the method during the school year. Aggregate reports show a summary of progress for all the students or for a subset of the students. Teachers are surveyed for information regarding their activities in implementing the method. Supervisors are also surveyed for information regarding their supervisory activities. Reports are prepared from the information collected on such teacher and supervisor surveys. Data entry screens and reports may be provided to teachers and supervisors over the Internet.

U.S. Pat. No. 6,299,452 by Wasowicz, et al. and issued on Oct. 9, 2001, is for a diagnostic system and method for phonological awareness, phonological processing, and reading skill testing. It discloses a diagnostic system and method for evaluating one or more phonological awareness, phonological processing and reading skills of an individual to detect phonological awareness, phonological processing and reading skill deficiencies in the individual so that the risk of developing a reading deficiency is reduced and existing reading deficiencies are remediated. The system may use graphical games to test the individual's ability in a plurality of different phonological awareness, phonological processing and reading skills. The system may use speech recognition technology to interact with the tests.

U.S. Pat. No. 6,144,838 by Sheehan and issued on Nov. 7, 2000, is for a tree-based approach to proficiency scaling and diagnostic assessment. It discloses a method for diagnostic assessment and proficiency scaling of test results. The method uses as input a vector of item difficulty estimates for each of n items and a matrix of hypothesized skill classifications for each of said n items on each of k skills.

U.S. Pat. No. 6,077,085 by Parry, et al. and issued on Jun. 20, 2000, is for technology assisted learning. It discloses the systems, methods and apparatus of preferred embodiments of the present invention that provide an integrated instructional system directed to learning a specific task or concept. Some embodiments are particularly suited for language instruction and some embodiments will accommodate a group of students with differing native languages.

U.S. Pat. No. 5,991,595 by Romano, et al. and issued on Nov. 23, 1999, is for a computerized system for scoring constructed responses and methods for training, monitoring, and evaluating human rater's scoring of constructed responses. It discloses systems and methods for presentation to raters of constructed responses to test questions in electronic workfolders.

U.S. Pat. No. 5,987,302 by Driscoll, et al. and issued on Nov. 16, 1999, is for an on-line essay evaluation system. It discloses systems and methods for on-line essay evaluation that offer students the opportunity to prepare practice essays, submit the essays to trained, expert readers, and retrieve an evaluation at the student's convenience.

U.S. Pat. No. 5,797,754 by Griswold, et al. and issued on Aug. 25, 1998, is for a method and system for computerized learning, response, and evaluation. It discloses a method and system for computerizing learning, response, and evaluation. The computerized system comprises a central processing unit and related memory and storage capacity to operate a learning, response, and evaluation system stored in a computer program. The learning, response, and evaluation system comprises an authoring portion and a presentation portion. Through the use of intuitive interface elements, the authoring portion allows an author to quickly and easily construct a lesson from a pool of relevant data. Due to the design and capabilities provided, the authoring portion reduces the time it takes for an author to learn how to construct a lesson and reduces the time it takes to construct the lesson.

U.S. Pat. No. 5,788,508 by Lee, et al. and issued on Aug. 4, 1998, is for an interactive computer aided natural learning method and apparatus. It discloses an educational method and system for executing the method, to improve the efficiency of individual learning by monitoring the student's progress and pacing the course material to the student's ability to comprehend and learn. This method and system also reduces the teachers's administrative and paperwork burden. Interactive multimedia technology is combined with unique courseware development to provide a flexible teaching tool and student monitoring system.

U.S. Pat. No. 5,480,306 by Liu and issued on Jan. 2, 1996, is for a language learning apparatus and method utilizing optical code as input medium. It discloses a language learning apparatus using optical code as input medium. An optical code/bar code is associated with each of a number of words, sentences, animal cries and sounds of music instruments.

U.S. Pat. No. 5,441,415 by Lee, et al. and issued on Aug. 15, 1995, is for an interactive computer aided natural learning method and apparatus. It discloses an educational method and system for executing the method, to improve the efficiency of individual learning by monitoring the student's progress and pacing the course material to the student's ability to comprehend and learn. This method and system also reduces the teachers's administrative and paperwork burden. Interactive multimedia technology is combined with unique courseware development to provide a flexible teaching tool and student monitoring system.

U.S. Pat. No. 5,421,730 by Lasker, III, et al. and issued on Jun. 6, 1995, is for an interactive learning system providing user feedback. It discloses an interactive learning system for providing various modes of instruction relating to a syntax-intensive subject matter such as a computer program language. The modes of instruction may include a video lesson mode of instruction, a reference text mode of instruction and a syntax analysis mode of instruction in which the user attempts to answer questions presented by the system. The user's entries are analyzed for proper syntax and if any errors are found therein, the user is provided visual feedback relating to any errors found in the entries.

U.S. Pat. No. 5,308,244 by Hirose and issued on May 3, 1994, is for a learning device. It discloses a learning device with an information processing unit, a keyboard for inputting characters, an information storage medium for storing a variety of data, a CRT display for displaying characters and/or figures, and a mouse for designating a specific location on the CRT display.

U.S. Pat. No. 5,261,823 by Kurokawa and issued on Nov. 16, 1993, is for an electronic learning machine which is capable of giving learning problems matching the student's scholastic ability. It discloses an electronic learning machine having an input unit for inputting data relating to a specific student. When the data relating to the student is entered by the input unit, a select unit selects the scholastic achievement data related to the student from a first storage unit. A control unit then selects, when so directed, problem information matching the student's scholastic ability from problem information at all difficulty levels stored in a second storage unit and displays the selected problems on the display or on a printing paper. Thus, the student is faced with problems at a difficulty level matching his/her scholastic ability to enhance learning.

U.S. Pat. No. 5,259,766 by Sack, et al. and issued on Nov. 9, 1993, is for a method and system for interactive computer science testing, analysis and feedback. It discloses a method and system for administering to a student a problem in computer science for testing, analysis and feedback. The student is provided with an item pool of predetermined test problems to be selected by the student. The student inputs a solution in response to the problem selected, and the solution program is converted, by lexing and parsing, into an abstract syntax tree representation.

U.S. Pat. No. 5,180,309 by Egnor and issued on Jan. 19, 1993, is for an automated answer evaluation and scoring system and method. It discloses an apparatus and method for achieving automated evaluation and scoring of a participant's response to questions selected pseudo-randomly.

U.S. Pat. No. 5,059,127 by Lewis, et al. and issued on Oct. 22, 1991, is for a computerized mastery testing system, a computer administered variable length sequential testing system for making pass/fail decisions. It discloses a computerized mastery testing system providing for the computerized implementation of sequential testing in order to reduce test length without sacrificing mastery classification accuracy. The mastery testing system is based on Item Response Theory and Bayesian Decision Theory which are used to qualify collections of test items, administered as a unit, and determine the decision rules regarding examinee's responses thereto.

U.S. Pat. No. 5,002,491 by Abrahamson, et al. and issued on Mar. 26, 1991, is for an electronic classroom system enabling interactive self-paced learning. It discloses an interactive electronic classroom system for enabling teachers to teach students concepts and to receive immediate feedback regarding how well the students have learned the concepts.

U.S. Pat. No. 4,958,284 by Bishop, et al. and issued on Sep. 18, 1990, is for an open ended question analysis system and method. It discloses a method and system for data processing open-ended respondent answers to open-ended questions that provides reproducible categorized dynamically variable coding of the open-ended respondent answers to the open-ended questions. The data processor has an updateable retrievable word dictionary of words stored therein with the open-ended answers comprising words. The open-ended answers are input to the data processor and classified into corresponding word types such as keywords, modifiers, skip words, connectors, and negative words, with the combined keywords and associated modifiers forming key phrases. The input words are converted into corresponding binary coded words for providing a binary defined sentence corresponding to the input open-ended respondent answer.

U.S. Pat. No. 4,895,518 by Arnold, et al. and issued on Jan. 23, 1990, is for a computerized diagnostic reasoning evaluation system. It discloses a system for assessing the diagnostic reasoning ability of learners engaged in a field of study employs a coded situation test and utilizes a computerized process for grading examinations taken by the learners and for rating their capacity for diagnostic reasoning.

U.S. Pat. No. 4,820,165 by Kanapa and issued on Apr. 11, 1989, is for a method and kit for learning science as a language. It discloses a new programming and feedback system for learning science as a language. The zero information based system and kit of the present invention allow verbalization of science subjects in a substantially shorter period of time than possible by conventional techniques.

U.S. Pat. No. 4,445,869 by Wasserman and issued on May 1, 1984, is for a teaching method and apparatus. It discloses a teaching method and apparatus that provides an organizational plan for writing and creates a comfortable mode of expression for all individuals by allowing such individuals to consciously examine the composition process and develop a set of writing experiences which is designed to improve their ability to write.

U.S. Patent Application 20050256663 by Fujimori, et al. and published on Nov. 17, 2005, is for a test system and control method thereof. It discloses a test system that realizes in an English ability test, etc. not only binary correct-false evaluation but also a partial score. The test system uses a computer including an input/output device and a network such as the Internet, etc., and uses a partial test score model obtained by amending the conventional Item Response Theory in estimating an item parameter and ability.

U.S. Patent Application 20050084829 by Peters and published on Apr. 21, 2005, is for tools and method for acquiring foreign languages. It discloses that foreign languages are effectively learned and taught by using the tools. With the tools, the learners are able to understand their purpose, have clear language targets to be achieved within a set period of time, and know how they will achieve those targets. The tools and method allow for the recording, identification, categorization, correction, analysis, and historical tracking of new words, phrases, and mistakes of their own language usage.

U.S. Patent Application 20050026118 by Chen, et al. and published on Feb. 3, 2005, is for a Chinese/English vocabulary learning tool. It discloses a methodology for helping a student to learn vocabulary in Simplified Chinese, Traditional Chinese, English, and Pin Yin. The present invention comprises a Selection Program (SP), a Testing Program (TP), and a Character Sizing Program (CSP). The SP allows the user to select a Chinese-English textbook chapter, a question language, and an answer language. The SP then displays the chapter vocabulary for review and runs the TP. The TP calculates the probability factors for the vocabulary terms and determines a question to ask. The TP uses two Unicode tables to check to see if the answer is correct. The TP decrements the probability factor for wrong answers and increments the probability factor for right answers. The TP ends when all of the probability factors are equal to one. The CSP changes the font size of the Chinese characters.

U.S. Patent Application 20030091965 by Lin, et al. and published on May 15, 2003, is for a step-by-step English teaching method and its computer accessible recording medium. It discloses a systematic English teaching method and its computer accessible recording medium.

There exists need for a better method to test English proficiency. There is still room for improvement within the art.

### 1. Field of the Invention

### 2. Description of related art including information disclosed under 37 CFR § 1.97** > and 1.98<.

### SUMMARY OF THE INVENTION

The present invention is an Internet based English language test online designed to help Human Resources Departments in Non-English speaking countries find the right person for the bilingual job, The system will also assess employee's English language communication skills, on a scale from 0-100%. The system is job-business oriented and measures the participant's skills and proficiency for effective communication at the workplace.

The system is also the ideal exit test for those universities in Non-English speaking countries that have their students take an English language skills and proficiency test as a graduation requirement and/or preparation for the job search.

The system will have a standard test with a follow up VIP test if the test taker qualifies after taking the standard test. The Standard Test which is a set of 100 random questions with a computerized assessment test that evaluates the participant's skills and knowledge in 4 areas: listening, reading, grammar & vocabulary. The VIP test is the first highly personalized proficiency test online, that integrates all 4 skills; listening, reading, writing and speaking, in order to evaluate the participant's communicative competence in the English language.

The process is more efficient, effective, accurate and functional than the current art.

### GLOSSARY OF TERMS

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows multiple Users are connected to the system;

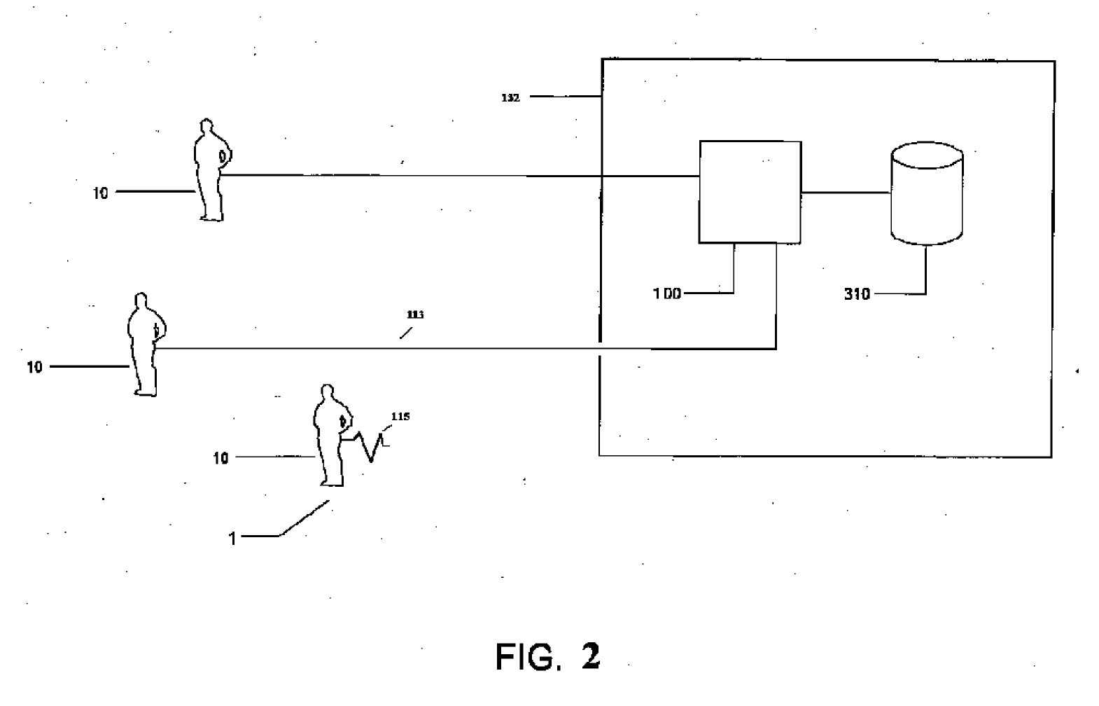

FIG. 3 shows the sample question area;

FIG. 4 displays the four skills in the VIP test;

FIG. 5 shows a circular graph representing the system; and

FIG. 6 shows a flowchart explaining the adaptive/random question methodology.

### DESCRIPTION OF THE PREFERRED EMBODIMENT

There are a number of significant design features and improvements incorporated within the invention.

The present invention relates to system 1 that is an Internet-based English language test online which is designed to help Human Resources Departments in Non-English speaking countries find the right person for the bilingual job and/or assess employee's English language communication skills, on a scale from 0-100%.

The system 1 is also the ideal exit test for those universities in Non-English speaking countries that have their students take an English language skills and proficiency test as a graduation requirement and/or preparation for the job search.

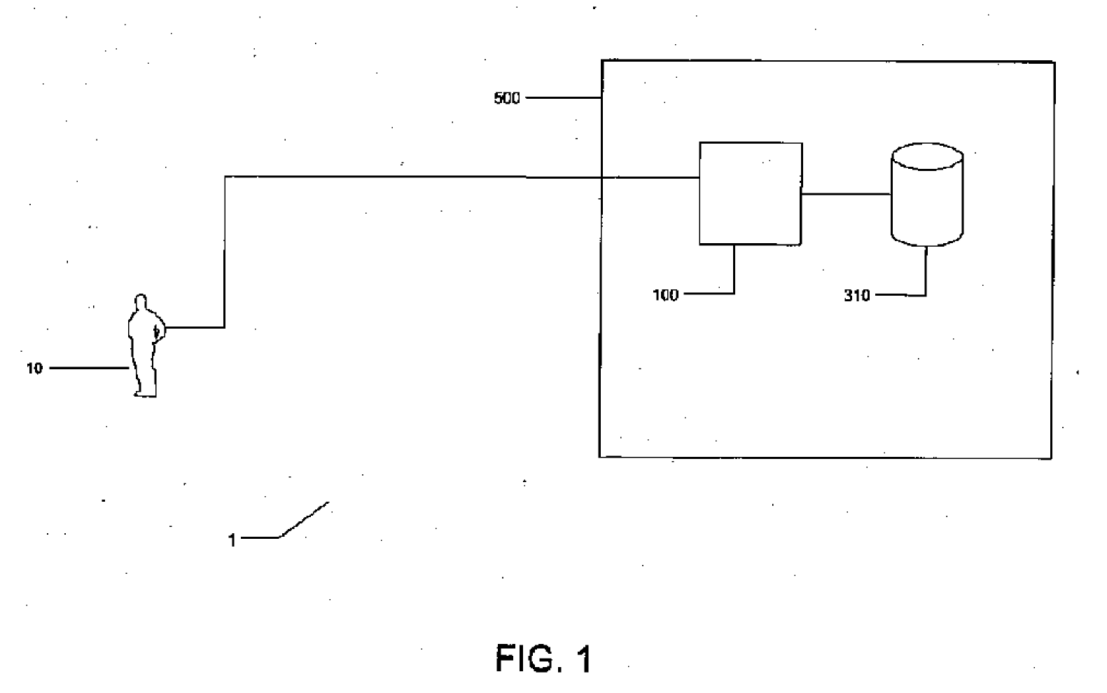

FIG. 1 illustrates a functional diagram of a computer network for World Wide Web 500 access to the System 1 which runs the game 2 from a plurality of Users 10 who access the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each player 10 will have a display device such as a monitor and input device like a keyboard. This display and input device can even be a PDA like a Blackburn.

The Users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System Web Site 100.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 allows for secure input, data transfer and storage of a wide array of information. The system 1 allows and handles the direct transfer of security rights for the Users 10. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows™ version, and the second embodiment can be referred to as a web browser version. The functionality of both embodiments is essentially the same; however, the second embodiment (the web browser version) may incorporate some additional enhancements, as further discussed below. The data processing system in both embodiments utilizes a secure environment to transmit all data through encryption/decryption. The data processing system further provides for an audit trail of modifications made to the recorded data.

The data processing system 1 for both embodiments includes computer processing means for processing data, storage means for storing data on a storage medium, and communication means for transferring data in a secure environment.

For the first embodiment on the Windows™ version, the data is entered on remote work stations and stored in local databases until the user performs a data transmission function which electronically transfers the data to a central database. The central database acts as a central repository enabling multiple off-site users to view and/or modify data, and generate reports or output.

For the second embodiment (the web browser version), it can be conceptually broken down into two main components or groupings that allow the data processing system to achieve its functionality. They are as follows: (1) a main database that acts as the central repository for data entered into the system and (2) a means for processing data or computer software means in the form of coded computer instructions.

For the web browser version, it is unnecessary to have the different installations of the computer software because the web server computer has the entire means for processing loaded thereon. The user in the web browser version logs on to the website and then performs desired functions based upon functions made available to the type of user. There are two ways in which data is entered through the browser version: (1) through a website and transmitted via a LAN or the worldwide web to the web server. The web server then forwards the data to the database; or (2) through a data feed from a separate third party electronic online trading system and transmitted via a LAN or the worldwide web to the web server or an FTP server. The web server or FTP server then forwards the data to the main database. Transmission of data in the second embodiment via the worldwide web or LAN is also secure utilizing data encryption/decryption provided by SSL. Other than consolidation of the means for processing data at the web server computer, and the manner in which data is entered and retrieved through a website, the first and second embodiments have the same functionality, except for those additional features discussed below with respect to the second embodiment.

The user 10 will log on to the system 1 using a username and password using generally accepted username and password rules. This username and password will be unique to the user 10. The users should be using some type of computer system that will allow him or her to hear and communicate verbally to the system 1, such as through a microphone and headset. The user 10 will have a profile section on the system which will store required and informative data about the user 10.

The user 10 will click on a “start test now” button to start the test in the preferred embodiment.

The system 1 has 2 components:

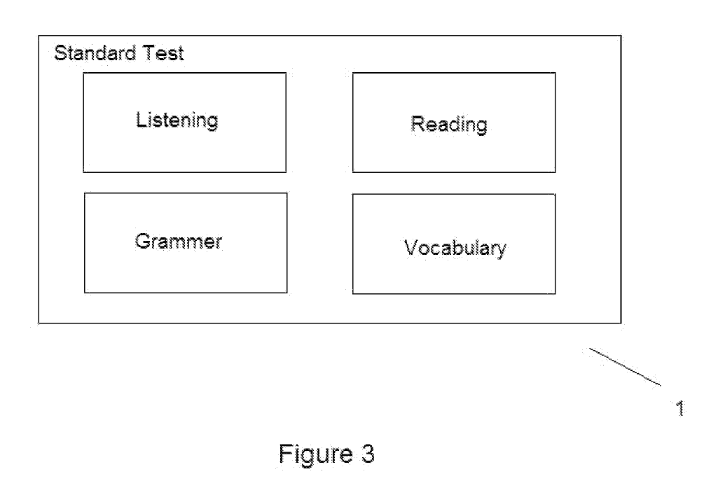

As shown in FIG. 3, the first component is a System 1^{st} Standard Test 10 which is a set of 100 random questions with a computerized assessment test that evaluates the participant's skills and knowledge in 4 areas: listening, reading, grammar and vocabulary.

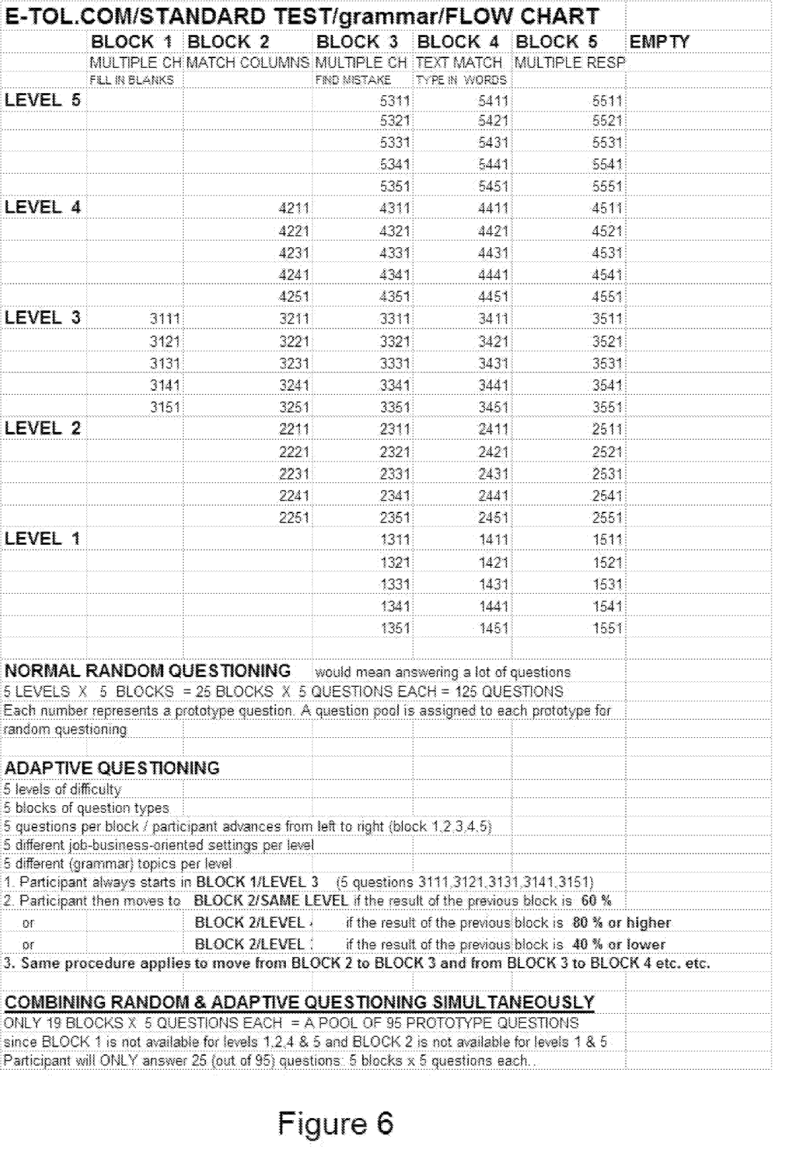

In the preferred embodiment, each area is organized in 5 levels of difficulty and 5 blocks of question types, that could provide for a total of 25 level/blocks. However adaptive question methodology reduces the number of level/blocks from 25 to 19 as each participant starts in level 3 as shown in the flow chart in FIG. 6. A number of 19 level/blocks with 5 prototype questions each gives a total of 95 prototype questions per area. A number of alternative questions are assigned to each prototype question, thus multiplying the number of questions per area from 95 up to several hundred! Due to the system's adaptive/random question methodology the test taker will only need to answer 25 questions per area. Each area will contain a set number, such as 95, prototype questions, with 25 questions selected for the test through adaptive question methodology. These 25 questions per area are organized in 5 levels of difficulty with 5 blocks of 5 questions each. A different question type is assigned to each block: multiple choice, match the columns, text match, multiple response etc., and each prototype question stands for a specific level/question type/grammar/conversation-context combination.

The questions will be based on combing random and adaptive questioning simultaneously. A random questioning of the prototype questions will be asked. If the user 10 gets a percent of the first set of questions correct they will move on to more difficult questions. For example, if the user 10 gets 80 percent or more right in a question level/block of 5 questions he will move up to the next higher level of difficulty in the next question block, if he gets 60 percent right he will take the next question block in the same level of difficulty and if he gets only 40 percent or less right, he will go down to the next lower level of difficulty in the following question block.

For example: A test taker always starts in level 3. Depending on the percentage of correct answers in the 1^{st} question block, he will take the 2^{nd} block also in level 3 or move up to level 4 or move down to level 2 as shown in the flow chart in FIG. 6. The same procedure after the 2^{nd} block, 3^{rd} block etc.

The system 1 will use an embedded in an adaptive question methodology, which reduces the number of questions by 50% and therefore the testing time from 120 minutes to 60 minutes (compared to the testing time of traditional paper tests). The system Standard Test runs on internet technology and under commercial software licenses.

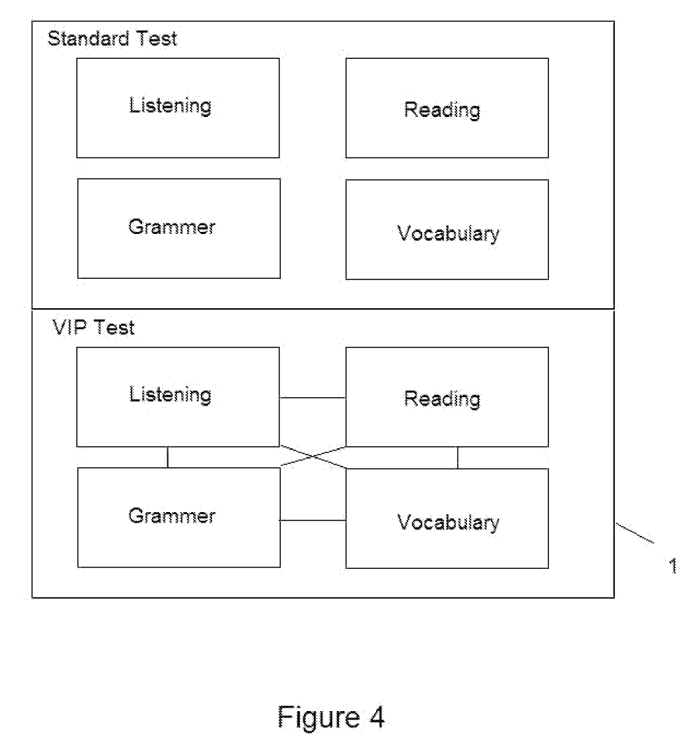

The second component is a System VIP test. The VIP test is the first highly personalized proficiency test online, that integrates all 4 skills, as shown in FIG. 4, listening, reading, writing and speaking, in order to evaluate the participant's communicative competence in the English language. It is a follow-up test for those participants who have successfully completed their first system Standard Test and covers 4 areas:

1. Reading about topic (e.g. “globalization”), where “X” opinion is expressed.

2. Listening about the same topic, where a different opinion is expressed.

3. Live Interview which in the preferred embodiment would take between 15 and 20 minutes where the participant discusses the reading and listening topic with his/her interviewer. The participant is asked to come up with spontaneous natural responses and is encouraged to convince the interviewer of his/her point of view.

4. Written exposition of about 200 words about the same topic.

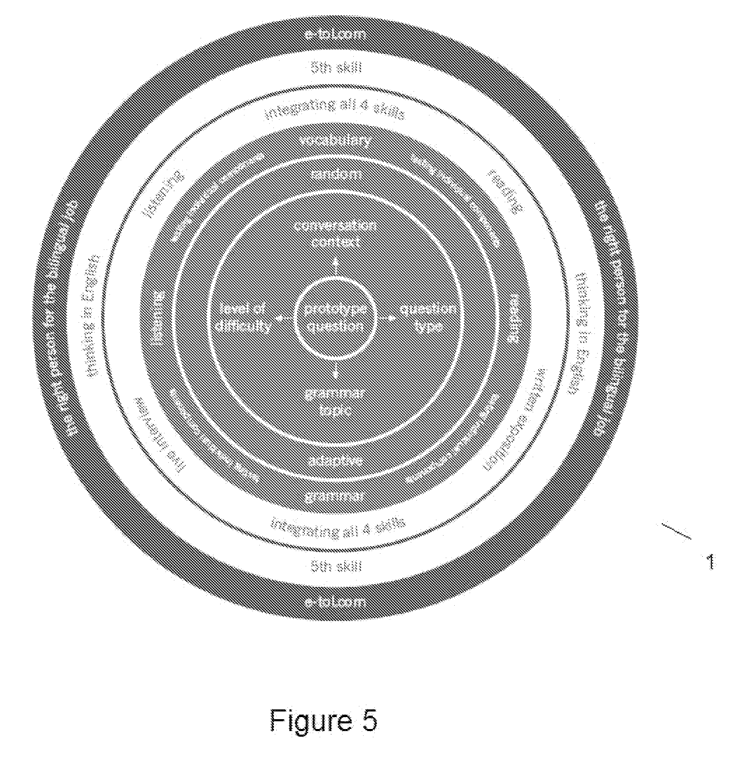

Beyond skills and proficiency, the system's VIP TEST helps assess the participant's skill of thinking in English. The process is summarized in FIG. 5 as a circular chart.

This system can run on regular phone services as well as on internet phone services.

The system 1 will inform the participant as well as the entity that desires the test being done of his or her grade. The system 1 will also assess employee's English language communication skills, on a scale from 0-100%. This notification could be via an E-mail, phone communications, a letter or made available via internet link for print out. In the preferred embodiment, the results will be in an area of the user's profile called my results.

The system 1 can be used for other languages besides English as well.

### CONCLUSION

The current invention is a solution for many HR departments and universities in Non-English speaking countries. It is a well balanced formula that combines a variety of technologies, software programs, question types, question methodologies and learning processes in a given sequence.

Although the present invention has been described in considerable detail with reference to certain preferred versions thereof, other versions are possible. Therefore, the point and scope of the appended claims should not be limited to the description of the preferred versions contained herein. The system is not limited to any particular programming language or computer platform.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of testing language comprehension comprising of a system having a standard test with a follow up VIP test if the test taker qualifies.

2. A method according to claim 1 further comprising having said standard test consist of 4 areas: listening, reading, grammar and vocabulary.

3. A method according to claim 1 further comprising having said VIP test integrates listening, reading, writing and speaking.

4. A method according to claim 1 further comprising having said standard test consist of adaptive/random questions.

5. A method according to claim 1 further comprising having questions of said standard test get harder, easier or stay the same if the user answers a certain percentage correctly.

6. A method according to claim 1 further comprising having said VIP test consists of reading about topic where an opinion is expressed.

7. A method according to claim 1 further comprising having said VIP test consists of a listening about the same topic where a different opinion is expressed.

8. A method according to claim 1 further comprising having said VIP test consists of a live interview where the participant discusses a topic.

9. A method according to claim 8 further comprising having said interview being of a length of time between 15 and 20 minutes.

10. A method according to claim 1 further comprising having said VIP test consists of a written exposition about a same topic.

11. A method according to claim 1 further comprising having said VIP test consists of a written exposition about a same topic.

12. A method according to claim 1 further comprising having said VIP test consists of reading about a topic where an opinion is expressed, listening about the same topic where a different opinion is expressed, a live interview where the participant discusses the topic with the interviewer and a written exposition about the said topic.

13. A method according to claim 12 further comprising having said interview being of a length of time between 15 and 20 minutes.

14. A method according to claim 1 further comprising having said system running on a computer processor.

15. A method according to claim 14 further comprising having said system being accessed through the Internet.

16. A method according to claim 14 further comprising having said system being accessed through the Internet.

17. A method of testing language comprehension comprising of a system having a standard test consisting of random questions with having said questions of said standard test get harder if the user answers a certain percentage correct and with a follow up VIP test if the test taker qualifies where said standard test consist of 4 areas: listening, reading, grammar and vocabulary and VIP test consists of reading about a topic where an opinion is expressed, listening about the same topic where a different opinion is expressed, a live interview where the participant discusses the topic with the interviewer and a written exposition about the said topic.

18. A method according to claim 17 further comprising having said interview being of a length of time between 15 and 20 minutes.

19. A method according to claim 17 further comprising having said system running on a computer processor.

20. A method according to claim 19 further comprising having said system being accessed through the Internet.
